(19) United States
(12) Patent Application Publication
(10) Pub. No.: US 2020/0353797 A1
(43) Pub. Date: Nov. 12, 2020

(54) ARCHITECTURE AND METHOD FOR BATTERY CHARGER WITH DUAL OUTPUT VOLTAGE AND CHARGE MANAGEMENT FOR A TRANSPORT REFRIGERATION UNIT

(71) Applicant: Carrier Corporation, Palm Beach Gardens, FL (US)

(72) Inventor: Jamal Zarrabi, Les Andelys (FR)

(21) Appl. No.: 16/960,660

(22) PCT Filed: Jan. 12, 2018
(86) PCT No.: PCT/IB2018/000099

§ 371 Date: Jul. 8, 2020

(51) Int. Cl. B60H 1/32; B60H 1/00; H02J 7/00

(52) U.S. Cl. CPC B60H 1/3232; H02J 2310/40; H02J 7/0031; B60H 1/00428

(57) ABSTRACT

A method and system for charge management for a battery in a transport refrigeration unit. The method includes configuring the transport refrigeration unit with a plurality of DC power sources operable from a primary power source, connecting a first DC power source as a battery charger operably connected to the battery and configured to provide charging power to the battery, and connecting a second DC power source as a power source for at least one of a controller for the transport refrigeration system and a controller for the battery charger. The method also includes monitoring a voltage of the battery and interrupting the charging of the battery based on the monitoring of a voltage of the battery.

### TECHNICAL FIELD

The present disclosure relates to a method and system for charging a battery in a transport refrigeration system. More particularly, employing a battery charging system and methodology for improving efficiency and reliability of a battery therein.

### BACKGROUND

A typical refrigerated cargo truck or refrigerated truck trailer, such as those utilized to transport a cargo via sea, rail or road, is a truck or trailer having a cargo compartment, modified to include a refrigeration unit located at one end of the truck or trailer. The refrigeration unit includes a compressor, condenser, expansion valve and evaporator serially connected by refrigerant lines in a closed refrigerant circuit in accord with known refrigerant vapor compression cycles. A power unit, including an engine, drives the compressor of the refrigeration unit, and is typically diesel powered, or in other applications natural gas powered. In many truck/trailer transport refrigeration systems, the compressor is driven by the engine shaft either through a belt drive or by a mechanical shaft-to-shaft link. In other systems, the engine drives a generator that generates electrical power, which in turn drives the compressor.

Manufacturers and operators of fleets of refrigerated trucks and refrigerated truck trailers desire to maximize operational efficiency of not only the refrigeration unit, but of the truck or tractor trailer system as a whole. In some systems transport refrigeration units include batteries to support operation of the refrigeration unit. These batteries include charging circuits to ensure that the batteries are always charged. However, sometimes as result of constant charging, the batteries may become excessively charged. Overcharging batteries reduces battery lifetime and wastes power.

### BRIEF DESCRIPTION

According to one embodiment described herein is a method and system for charge management for a battery in a transport refrigeration unit. The method includes configuring the transport refrigeration unit with a plurality of DC power sources operable from a primary power source, connecting a first DC power source as a battery charger operably connected to the battery and configured to provide charging power to the battery, and connecting a second DC power source as a power source for at least one of a controller for the transport refrigeration system and a controller for the battery charger. The method also includes monitoring a current drawn by the battery and voltage of the battery and interrupting the charging of the battery based on the monitoring of a current drawn by the battery and voltage of the battery.

According to one embodiment described herein is a transport refrigeration unit. The transport refrigeration unit including a source of AC power, the source of AC power configured to supply power to an AC load of the transport refrigeration unit, a battery charging module operably connected to the source of AC power and configured to convert the AC power to a first DC power with a first DC power source and a second DC power with a second DC power source, and a battery operably connected to the first DC power source, the first DC power source configured as a DC power source for the battery. The transport refrigeration unit also including at least one of a controller of the transport refrigeration unit and a controller of the battery charging module operably connected to the second DC power source, the second DC power source supplying the second DC power for at least one of a controller of the transport refrigeration unit and a controller and a voltage monitor operably connected to the battery and to at least one of the controller of the transport refrigeration unit and the controller of the battery charging module, the voltage monitor configured to measure the voltage of the battery. The controller of the battery charging module is configured to interrupt the first DC power supplied from the first DC power source independent of the second DC power source based on at least the voltage of the battery.

In addition to one or more of the features described above, or as an alternative, further embodiments may include that the battery charging module disconnects the first DC power supplied from the first DC power source based on at least the voltage of the battery.

In addition to one or more of the features described above, or as an alternative, further embodiments may include that the controller of the battery charging module is configured to interrupt the first DC power source from supplying power to the battery based on at least the voltage of the battery independent of the second DC power source.

In addition to one or more of the features described above, or as an alternative, further embodiments may include that the battery charging module is an AC/DC converter to convert the AC power to DC power and at least one of the first DC power and the second DC power are regulated.

In addition to one or more of the features described above, or as an alternative, further embodiments may include that the second DC power source is isolated from the first DC power source under selected conditions.

In addition to one or more of the features described above, or as an alternative, further embodiments may include that the isolation is a diode isolation.

In addition to one or more of the features described above, or as an alternative, further embodiments may include that the isolation configured to ensure that the second DC voltage generated the second DC power source is isolated from the first DC power source and the battery, and first DC voltage from the first DC power source is transmitted as the second DC voltage if the second DC power source is inoperative.

In addition to one or more of the features described above, or as an alternative, further embodiments may include a current sensor operably connected to the battery and to at least one of the controller of the transport refrigeration unit and the controller of the battery charging module, the current sensor configured to measure the current supplied to or from the battery, wherein the controller of the battery charging module is further configured to interrupt of the first DC power source independent of the second DC power source based on at least the current supplied to or from the battery.

In addition to one or more of the features described above, or as an alternative, further embodiments may include at least one of an evaporator fan and a compressor, wherein the AC power source supplies AC power to the at least one of an evaporator fan and a compressor.

In addition to one or more of the features described above, or as an alternative, further embodiments may include that the source of AC power includes an engine and a generator.

In addition to one or more of the features described above, or as an alternative, further embodiments may include the battery supplying power to at least one of the controller of the transport refrigeration unit and the controller of the battery charging module when the first DC output is interrupted.

In addition to one or more of the features described above, or as an alternative, further embodiments may include that interrupting the charging of the battery includes disconnecting the first DC power supplied from the first DC power source.

In addition to one or more of the features described above, or as an alternative, further embodiments may include that the configuring includes converting the AC power to DC power and at least one of the first DC power and the second DC power are regulated.

In addition to one or more of the features described above, or as an alternative, further embodiments may include isolating the second DC power source from the first DC power source under selected conditions.

In addition to one or more of the features described above, or as an alternative, further embodiments may include that the isolating is configured to ensure that the second DC voltage generated the second DC power source is isolated from the first DC power source and the battery, and first DC voltage from the first DC power source is transmitted as the second DC voltage if the second DC power source is inoperative.

In addition to one or more of the features described above, or as an alternative, further embodiments may include measuring the current supplied to or from the battery with a current sensor operably connected to the battery and to at least one of the controller of the transport refrigeration unit and the controller of the battery charging module, wherein the interrupting of the first DC power source independent of the second DC power source is further based on at least the current supplied to or from the battery.

In addition to one or more of the features described above, or as an alternative, further embodiments may include configuring the transport refrigeration unit to include at least one of an evaporator fan and a compressor, wherein the AC power source supplies AC power to the at least one of an evaporator fan and a compressor.

In addition to one or more of the features described above, or as an alternative, further embodiments may include that the primary power source is an AC power source and includes an engine and a generator.

In addition to one or more of the features described above, or as an alternative, further embodiments may include supplying power to at least one of the controller of the transport refrigeration unit and the controller of the battery charging module from the battery when the first DC output is interrupted.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The foregoing and other features and advantages of embodiments are apparent from the following detailed description taken in conjunction with the accompanying drawings in which:

FIG. 1 depicts a tractor trailer system having a transport refrigeration unit and a cargo compartment in accordance with an embodiment;

FIG. 2 depicts a transport refrigeration unit for a cargo compartment of the tractor trailer system of FIG. 1 in accordance with an embodiment;

FIG. 3 depicts a transport refrigeration unit power system for outputting regulated power in accordance with an embodiment; and

FIG. 4 depicts a simplified schematic of a battery charging module in a transport refrigeration unit power system in accordance with an embodiment; and

FIG. 5 is a flowchart of a process for operating the transport refrigeration unit power system in accordance with an embodiment.

### DETAILED DESCRIPTION

In general, embodiments herein relate generally to a battery charging circuit and configuration for the power system of a transport refrigeration unit. In particular separate outputs of the power system provide for power for the system, while a separate supply is employed for charging the battery. The system will provide an intelligently management for charging battery and at same time an independent power supply of all electronics components of unit to facilitate independent control. Such an architecture improves the function of the system in various operating modes by increasing efficiency and improving battery life and reliability.

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in Figure X may be labeled “Xa” and a similar feature in Figure Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

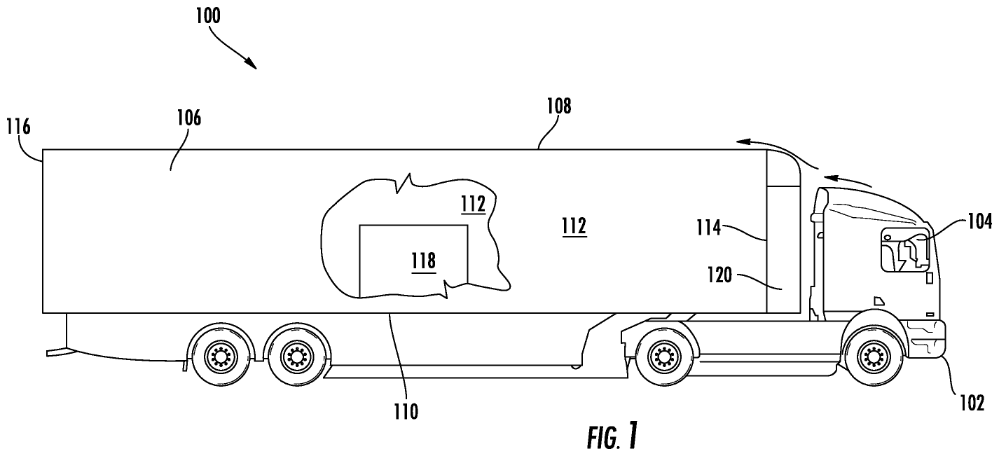

FIG. 1 is an embodiment of a tractor trailer system 100. The tractor trailer system 100 includes a tractor 102 including an operator's compartment or cab 104 and also including an engine, which acts as the drive system of the tractor trailer system 100. A trailer 106 is coupled to the tractor 102. The trailer 106 is a refrigerated trailer 106 and includes a top wall 108, a directly opposed bottom wall 110, opposed side walls 112, and a front wall 114, with the front wall 114 being closest to the tractor 102. The trailer 106 further includes a door or doors (not shown) at a rear wall 116, opposite the front wall 114. The walls of the trailer 106 define a cargo compartment. The trailer 106 is configured to maintain a cargo 118 located inside the cargo compartment at a selected temperature through the use of a transport refrigeration unit 120 located on the trailer 106. The transport refrigeration unit 120, as shown in FIG. 1, is located at or attached to the front wall 114.

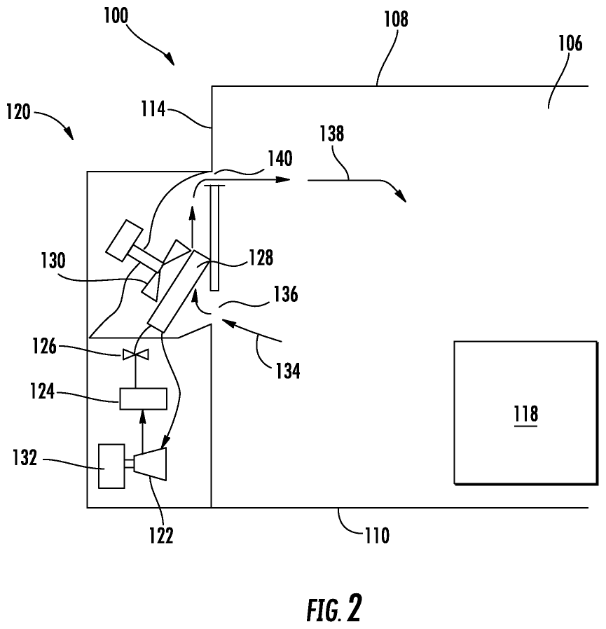

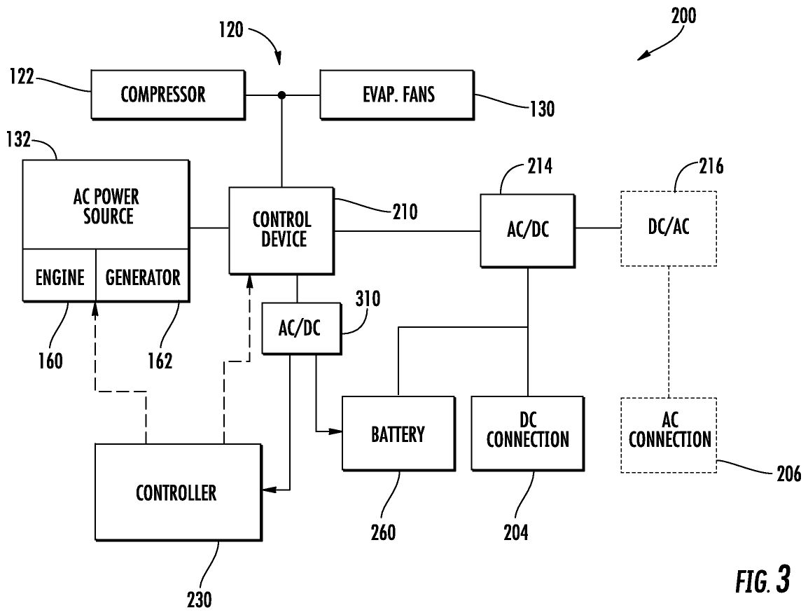

Referring now to FIG. 2, the transport refrigeration unit 120 is shown in more detail. The transport refrigeration unit 120 includes a compressor 122, a condenser 124, an expansion valve 126, an evaporator 128, and an evaporator fan 130. The compressor 122 is operably connected to an AC power source 132 which drives the compressor 122. The AC power source 132 may include an engine and a generator, as described herein with reference to FIG. 3.

Airflow is circulated into and through the cargo compartment of the trailer 106 by means of the transport refrigeration unit 120. A return airflow 134 flows into the transport refrigeration unit 120 from the cargo compartment of the trailer 106 through a refrigeration unit inlet 136, and across the evaporator 128 via the evaporator fan 130, thus cooling the return airflow 134. The cooled return airflow 134, now referred to as supply airflow 138, is supplied into the cargo compartment of the trailer 106 through a refrigeration unit outlet 140, which in some embodiments is located near the top wall 108 of the trailer 106. The supply airflow 138 cools the cargo 118 in the cargo compartment of the trailer 106.

FIG. 3 depicts a conventional transport refrigeration unit power system 200 for outputting conditioned, regulated power and/or for charging a battery. Shown in FIG. 3 is AC power source 132. As described above, the AC power source 132 may include an internal combustion engine 160 (e.g., a diesel engine) and a generator that produces unregulated AC power. In an exemplary embodiment, the generator 162 generates unregulated, three-phase AC power, with no regulation ability other than controlling the speed of engine 160.

The transport refrigeration unit power system 200 includes a control device 210 that connects the output of AC power source 132 to selected loads during various modes of operation of the transport refrigeration unit 120. In one embodiment the control device 210 connects the output of AC power source 132 to either the transport refrigeration unit 120 when the system calls for refrigeration or to auxiliary power connections, such as one or more DC power connections 204 and/or one or more AC power connections 206. When the control device operating in a first mode, the output of the AC power source 132 is connected to the compressor 122 and evaporator fan 130 of the transport refrigeration unit 120. When the control device 210 is in a second mode, the output of the AC power source 132 is connected to power conditioning modules 214 and 216, which are connected to the one or more DC power connections 204 or one or more AC power connections 206, respectively. A first power conditioning module 214 may be an AC to DC converter. The first power conditioning module 214 receives the unregulated, three-phase AC power from AC power source 132 and generates clean, stable, regulated and conditioned DC power (e.g., 24 VDC, 200 Amp). The regulated DC power is connected to the one or more DC power connections 204. The one or more DC power connections 204 may include, but not be limited to a DC battery charger. In another embodiment, the one or more DC power connections 204 may include a DC outlet, to which an operator can connect a DC load (e.g., soft drink pumps) or a DC load associated with the trailer, such as a lift gate.

A second power conditioning module 216 may optionally be employed as a DC to AC converter. The second power conditioning module 216 receives the clean, stable, regulated and conditioned DC power from the first power conditioning module 214 and produces clean, stable, regulated and conditioned AC power (e.g., 120/240 VAC, 20 Amp, 60 Hz). The regulated AC power is connected to the one or more AC power connections 206. The one or more AC power connections 206 may include an AC outlet, to which an operator can connect an AC load (e.g., cash registers, computers) or an AC load associated with the trailer (e.g., AC powered hand truck chargers).

A controller 230 controls various aspects of the transport refrigeration unit 120 and the transport refrigeration unit power system 200. Controller 230 can vary the speed of engine 160 depending on which mode of operation is selected.

Controller 230 also controls the control device 210.

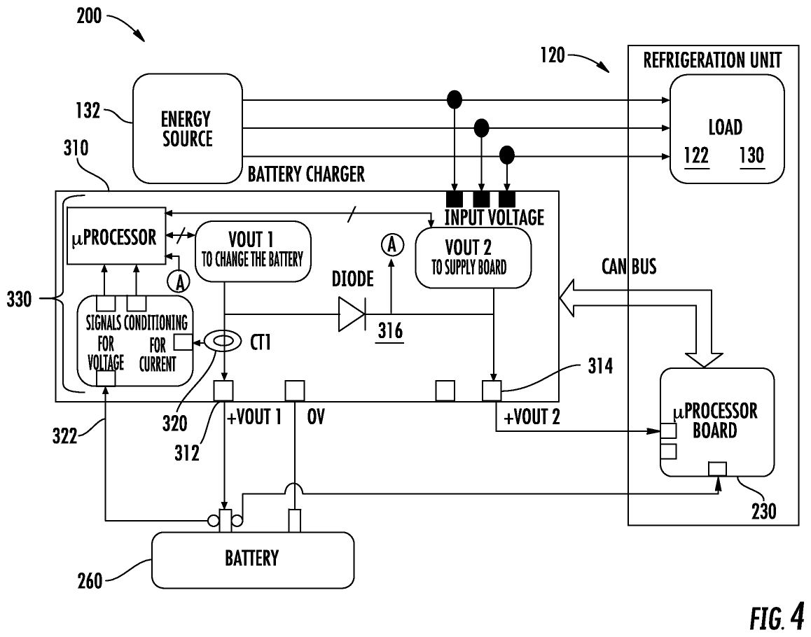

FIG. 4 depicts a partial view of the transport refrigeration unit power system 200 for controlling charging of the battery 260 in an exemplary embodiment. Shown in FIG. 4 is AC power source 132, as described above, the AC power source 132 may include an internal combustion engine 160 (e.g., a diesel engine) and a generator 162 that produces unregulated AC power. In an embodiment, the generator 162 generates unregulated, three-phase AC power, the AC power is somewhat regulated by controlling the speed of engine 160. In some embodiments, the control is more sophisticated and includes more optimal regulation of the generated AC power. In an embodiment, the transport refrigeration unit power system 200 is configured so that the output of AC power source 132 is operably connected to power control unit 210. The power control unit 210 is configured to control and direct application and routing of power to various subsystem components. In particular, the routing of power to and from the battery 260, as well as the routing and maintenance of power to the control unit 230 for the transport refrigeration unit power system 200. In a conventional transport refrigeration power system 200, a single DC power supply was commonly employed to provide power the system control unit e.g., 230 to ensure correct function of the refrigeration system 100, while at the same time charging the battery 260. Unfortunately this approach leads to inefficiencies with overcharging the battery 260 while also negatively impacting battery reliability. In the described embodiments, the function of charging the battery 260 is isolated from other functions of the transport refrigeration unit power system 200 and powering the controller 230, thereby facilitating separate output and controls for charging the battery. As a result, a more intelligent utilization, application, and integration of the battery 260 and the battery charging function is provided.

Continuing with FIGS. 3 and 4, for details on the operation and function of the battery charger 310 of an embodiment. The battery charger 310 receives the unregulated AC power from the generator 132 and formulates two independent, controllable DC voltage outputs. The first DC output denoted Vout1 312 is directed to the battery 260 for maintaining the charge on the battery 260 and the second DC output denoted Vout2 314 for providing excitation to the controller 230 for the transport refrigeration power system 120 as well as internally for the battery charger 310 and its controller 330. In an embodiment, both the first DC output Vout1 312 and the second DC output denoted Vout2 314 are configured to be separately regulated and controllable. Further, in an embodiment, the second DC output voltage Vout2 314 is configured to be greater than or equal to the first DC output voltage denoted Vout1 312. Configured this way, Vout2 314 remains isolated from Vout1 312 based on the configuration of the system 120 and specifically the battery charger 310. The first DC output 314 is configured to provide charging current for the battery 260. Controller 330 in the battery charger 310 is employed to control the first and second DC outputs 312, 314 respectively. In an embodiment, a current sensor 318 is employed to monitor the current supplied to/from the battery 260. In addition the voltage of the battery 260 is monitored by both the battery charger controller 330 as well as the controller 230 via line 322 for the transport refrigeration power system 120. The controller 330 executes a process for monitoring the status of the battery 260 and controlling the first DC voltage output 312 accordingly. In an embodiment, when the generator is operable, and the system power is available, the controller 330 enables the first and second DC outputs 312, 314 respectively to provide power. When operating under such conditions, when the battery 260 has achieved a full charge, the controller 330 disables the first DC outputs 312 thereby disconnecting and isolating the battery from, charging. This approach ensures that the battery 260 is properly charged, yet avoids excessively overcharging. Should the battery charge be depleted, such that additional charge is desired, then the first DC output 312 is enabled once again to provide charging current to the battery 260. In an embodiment, the activation of the first DC output 312 is based on at least the whether the battery voltage falls below a selected threshold. In other embodiments, the controller 330 employs more sophisticated processes based on the voltage of the battery 260, current drawn/supplied by the battery 260, temperature, time, and the like. For example, in an embodiment a current sensor 320 is employed and connected to the controller 330 to monitor the current supplied to/from the battery 260. In such a case, the application of charging (or removal thereof) may also be a function of the current supplied to/from the battery 260 as well. In some embodiments, a model of the battery 260 may be employed to facilitate predicting the state of charge of the battery 260, where the model also provides a basis for applying/removing the charging of the battery 260.

Continuing with FIGS. 3 and 4, in an embodiment, the controller 330 executes a process for monitoring and controlling the second DC voltage output 314. Once again, when the generator 132 is operable, and the system power is available, the controller 330 enables the first and second DC outputs 312, 314 respectively to provide power. When operating under such conditions, the second DC output 314 operates substantially independently of the first DC output 312, particularly as the first DC output 312 provides charging current to the battery 260, or when the controller disables the first X output 312 thereby disconnecting and isolating the battery from, charging. In an embodiment, the second DC output Vout2 314 directed to the controller 230 is isolated from the first DC output Vout1 312 via diode 316. This isolation ensures that if system power is interrupted, (e.g., from the generator 132, internal fault of the battery charger 310 generating Vout2 314, and the like) power will be continuously supplied to the controller 230 for the transport refrigeration power system 120 via either of Vout1 312 and/or the battery 260. It should be appreciated that because Vout2 314 is configured to be greater than or equal to Vout1 312, the diode 316 is normally reverse biased and not conducting. However, what Vout2 314 is not available the diode 316 conducts to ensure power is routed to the processor 230. In addition, the power continues to be supplied to the battery charger 310 and controller 330. In other words, when the first DC output 312 is interrupted, or primary power is interrupted, the battery 260 then supplies power to the controller 230 to ensure proper operation of the transport refrigeration system 100. In addition, excitation is provided through the isolation diode 316 to provide power to the battery charger 310 and controllers 230 and 330.

In this way, the transport refrigeration system 100 is configured to provide battery charging and battery backup under all operating conditions for the transport refrigeration system 100 while ensuring that the battery 260 is not charged excessively and thereby impacting overall efficiency of the system 100 and in particular the reliability and operating life of the battery 260.

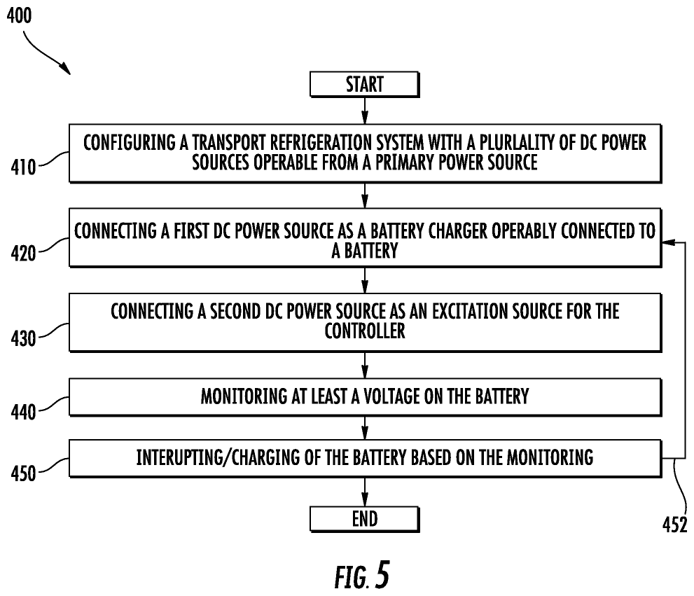

FIG. 5 depicts a flowchart of a method 400 of charge management for a battery 260 in a transport refrigeration system 100. The method 400 initiates at process step 410 with configuring the transport refrigeration system 100 and more specifically the power system 120 with two power sources to generate the first and second DC outputs 312, 314 respectively. The first power source and DC output 312 is configured to provide charging current for the battery 260 as depicted at process step 420. Likewise the second power source and DC output 314 is configured to provide excitation to the controller 230 as depicted at process step 430. In addition, as described above, the second power source and DC output 314 is also configured to provide excitation for the controller 330 for the battery charger 310. At process step 440 the method 400 continues with monitoring at least the voltage on the battery 260 and current drawn by the battery 260.

In addition, the current supplied to/from the battery 260 as measured by the current sensor 320 may optionally also be monitored to facilitate control of the charging of the battery 260. The method 400 continues at process step 450 with interrupting the charging of the battery 260 based on at least the monitored battery voltage, the current supplied to the battery 260, state of charge, temperature, time and the like. In addition, as depicted at line 452, select process steps may be recursively repeated to continuously monitor the charging state of the battery 260, and interrupting the charge as needed. Moreover, under selected conditions, once the first DC power source 312 has been interrupted and the controllers 230 or 330 are operating from the battery supplied power, if the battery state is such that additional charging is needed, the charging of the battery 260 is reinstated.

While the disclosure has been provided in detail in connection with only a limited number of embodiments, it should be readily understood that the present disclosure is not limited to such disclosed embodiments. Rather, embodiments can be modified to incorporate any number of variations, alterations, substitutions, combination, sub-combination, or equivalent arrangements not heretofore described, but which are commensurate with the spirit and scope of the disclosure. Additionally, while various embodiments have been described, it is to be understood that aspects of the disclosure may include only some of the described embodiments. Accordingly, embodiments are not to be seen as limited by the foregoing description, but only limited by the scope of the appended claims.

What is claimed is:

1. A transport refrigeration unit comprising:
a source of AC power, the source of AC power configured to supply power to an AC load of the transport refrigeration unit;
a battery charging module operably connected to the source of AC power, the battery charging module having a first DC power source and a second DC power source and configured to convert the AC power to a first DC power associated with the first DC power source and a second DC power associated with the second DC power source;
a battery operably connected to the first DC power source, the first DC power source configured as a DC power source for the battery;
at least one of a controller of the transport refrigeration unit and a controller of the battery charging module operably connected to the second DC power source, the second DC power source supplying the second DC power for at least one of the controller of the transport refrigeration unit and a controller of the battery charging module;
a voltage monitor operably connected to the battery and to at least one of the controller of the transport refrigeration unit and the controller of the battery charging module, the voltage monitor configured to measure a voltage of the battery; and
the controller of the battery charging module is configured to interrupt the first DC power source from supplying power to the battery based on at least the voltage of the battery.

2. The transport refrigeration unit of claim 1, wherein the battery charging module disconnects the first DC power supplied from the first DC power source based on at least the voltage of the battery.

3. The transport refrigeration unit of claim 1, wherein the controller of the battery charging module is configured to interrupt the first DC power source from supplying power to the battery based on at least the voltage of the battery independent of the second DC power source.

4. The transport refrigeration unit of claim 1, wherein the battery charging module is an AC/DC converter configured to convert the AC power to DC power and at least one of the first DC power and the second DC power are regulated.

5. The transport refrigeration unit of claim 1, further comprising that the second DC power source is isolated from the first DC power source under selected conditions.

6. The transport refrigeration unit of claim 5, wherein the isolation is a diode isolation.

7. The transport refrigeration unit of claim 5, wherein the isolation configured to ensure that the second DC voltage generated the second DC power source is isolated from the first DC power source and the battery, and first DC voltage from the first DC power source is transmitted as the second DC voltage if the second DC power source is inoperative.

8. The transport refrigeration unit of claim 1, further comprising a current sensor operably connected to the battery and to at least one of the controller of the transport refrigeration unit and the controller of the battery charging module, the current sensor configured to measure a current supplied to or from the battery, wherein the controller of the battery charging module is further configured to interrupt of the first DC power source independent of the second DC power source based on at least the current supplied to or from the battery.

9. The transport refrigeration unit of claim 1, further comprising at least one of an evaporator fan and a compressor, wherein the AC power source supplies AC power to the at least one of an evaporator fan and a compressor.

10. The transport refrigeration unit of claim 1, further including, the battery supplying power to at least one of the controller of the transport refrigeration unit and the controller of the battery charging module when the first DC power source is interrupted.

11. A method of charge management for a battery in a transport refrigeration unit, the method comprising:
configuring the transport refrigeration unit with a plurality of DC power sources operable from a primary power source;
connecting a first DC power source as a battery charger operably connected to the battery and configured to provide charging power to the battery;
connecting a second DC power source as a power source for at least one of a controller for the transport refrigeration system and a controller for the battery charger;
monitoring a voltage of the battery;
interrupting the charging of the battery based on the monitoring of a voltage of the battery.

12. The method of charge management for a battery of claim 11, wherein interrupting the charging of the battery includes disconnecting the first DC power supplied from the first DC power source.

13. The method of charge management for a battery of claim 11, wherein interrupting the charging of the battery is independent of the second DC power source.

14. The method of charge management for a battery of claim 11, wherein the configuring includes converting the AC power to DC power and at least one of the first DC power and the second DC power are regulated.

15. The method of charge management for a battery of claim 11, further comprising isolating the second DC power source from the first DC power source under selected conditions.

16. The method of charge management for a battery of claim 15, wherein the isolation is a diode isolation.

17. The method of charge management for a battery of claim 15, wherein the isolating is configured to ensure that the second DC voltage generated the second DC power source is isolated from the first DC power source and the battery, and first DC voltage from the first DC power source is transmitted as the second DC voltage if the second DC power source is inoperative.

18. The method of charge management for a battery of claim 11, further comprising measuring the current supplied to or from the battery with a current sensor operably connected to the battery and to at least one of the controller of the transport refrigeration unit and the controller of the battery charging module, wherein the interrupting of the first DC power source independent of the second DC power source is further based on at least the current supplied to or from the battery.

19. The method of charge management for a battery of claim 11, further comprising configuring the transport refrigeration unit to include at least one of an evaporator fan and a compressor, wherein the AC power source supplies AC power to the at least one of an evaporator fan and a compressor.

20. The method of charge management for a battery of claim 11, further including supplying power to at least one of the controller of the transport refrigeration unit and the controller of the battery charging module from the battery when the first DC power source is interrupted.
